(19) United States
(12) Patent Application Publication
(10) Pub. No.: US 2007/0150881 A1
(43) Pub. Date: Jun. 28, 2007

(54) Method and system for run-time cache logging

(75) Inventors: Charbel Khawand, Miami, FL (US); Jianping W. Miller, Coral Springs, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/315,396

(22) Filed: Dec. 22, 2005

(51) Int. Cl. G06F 9/44; G06F 9/45

(52) U.S. Cl. 717/162; 717/154

(57) ABSTRACT

A method (400) and system (106) is provided for run-time cache optimization. The method includes profiling (402) a performance of a program code during a run-time execution, logging (408) the performance for producing a cache log, and rearranging (410) a portion of program code in view of the cache log for producing a rearranged portion. The rearranged portion is supplied to a memory management unit (240) for managing at least one cache memory (110-140). The cache log can be collected during a real-time operation of a communication device and is fed back to a linking process (244) to maximize a cache locality compile-time. The method further includes loading a saved profile corresponding with a run-time operating mode, and reprogramming a new code image associated with the saved profile.

### FIELD OF THE INVENTION

The embodiments herein relate generally to methods and systems for inter-processor communication, and more particularly cache memory.

### DESCRIPTION OF THE RELATED ART

The performance gap between processors and memory has widened and is expected to widen even further as higher speed processors are introduced in the market. Processor performance has dramatically improved over memory latency, which has improved only modestly in comparison. The performance is dependent on the rate at which data is exchanged between a processor and a memory. Mobile communication devices, having limited battery life, rely on power efficient inter-processor communication performance. Computational performance in an embedded product such as a cell phone or personal digital assistant can severely degrade when data is accessed using slower memory. The performance can degrade to an extent such that a processor stall can result in unexpectedly terminating a voice call.

Processors employ caches to improve the efficiency by which the processor interfaces the memory. Cache is a mechanism between main memory and the processor to improve effective memory transfer rates and raise processor speeds. As the processor processes data, it first looks in the cache memory to find the data which may be placed in the cache from a previous reading of data, and if it does not find the data, it proceeds to do the more time-consuming reading of data from larger memory. Power consumption is directly proportional to cache performance.

The cache is a local memory that stores sections of data or code which are accessed more frequently than other sections. The processor can access the data from the higher-speed local memory more efficiently. A computer can store possibly one, two, or even three levels of caches. Embedded products operating on limited power can require memory that is high-speed and efficient. It is widely accepted that caches significantly improve the performance of programs, since most of the programs exhibit temporal and/or spatial locality in their memory reference. However, highly computational programs that access large amounts of data can exceed the cache capacity and thus lower the degree of cache locality. Efficiently exploiting locality of reference is fundamental to realizing high levels of performance on modern processors.

### SUMMARY

Embodiments of the invention concern a method and system for run-time cache optimization. The system can include a cache logger for profiling performance of a program code during a run-time execution thereby producing a cache log, and a memory management controller for rearranging at least a portion of the program code in view of the profiling for producing a rearranged portion that can increase a cache locality of reference. The memory management controller can provide the rearranged program code to a memory management unit that manages, during runtime, at least one cache memory in accordance with the cache log. Different cache logs pertaining to different operational modes can be collected during a real-time operation of a device (such as a communication device) and can be fed back to a linking process to maximize a cache locality compile time.

In accordance with another aspect of the invention, a method for run-time cache optimization can include profiling a performance of a program code during a run-time execution, logging the performance for producing a cache log, and rearranging a portion of program code in view of the cache log for producing a rearranged portion. The rearranged portion can be supplied to a memory management unit for managing at least one cache memory. The cache log can be collected during a run-time operation of a communication device and can be fed back to a linking process to maximize a cache locality compile time.

In accordance with another aspect of the invention, there is provided a machine readable storage, having stored thereon a computer program having a plurality of code sections executable by a portable computing device. The portable computing device can perform the steps of profiling a performance of a program code during a run-time execution, logging the performance for producing a cache log; and rearranging a portion of program code in view of the cache log for producing a rearranged portion. The rearranged portion can be supplied to a memory management unit for managing at least one cache memory through a linker. The cache log can be collected during a real-time operation of a communication device and can be fed back to a linking process to maximize a cache locality compile time.

### BRIEF DESCRIPTION OF THE DRAWINGS

The features of the system, which are believed to be novel, are set forth with particularity in the appended claims. The embodiments herein, can be understood by reference to the following description, taken in conjunction with the accompanying drawings, in the several figures of which like reference numerals identify like elements, and in which:

FIG. 1 illustrates a memory hierarchy in accordance with an embodiment of the inventive arrangements;

FIG. 2 depicts a memory management block in accordance with an embodiment of the inventive arrangements; and

FIG. 3 depicts a function database table in accordance with an embodiment of the inventive arrangements.

FIG. 4 depicts a method for run-time cache optimization in accordance with an embodiment of the inventive arrangements.

### DETAILED DESCRIPTION

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “suppressing” can be defined as reducing or removing, either partially or completely. The term “processing” can be defined as number of suitable processors, controllers, units, or the like that carry out a pre-programmed or programmed set of instructions.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

The term “Physical” memory is defined as the memory actually connected to the hardware. The term “Logical” memory is defined as the memory currently located a the processor's address space. The term function is defined as a small program that performs specific tasks and can be compiled and linked as a relocatable code object. The term “processing” can be defined as number of suitable processors, controllers, units, or the like that carry out a pre-programmed or programmed set of instructions.

Platform architectures in embedded product offerings such as cell phones and digital assistants generally combine multiple processing cores. A typical architecture can combine a Digital Signal Processing (DSP) core(s) with a Host Application core(s) and several memory sub-systems. The cores can share data when streaming inter-processor communication (IPC) data between the cores or running program and data from the cores. The cores can support powerful computations though can be limited in performance by memory bottlenecks. The deployment of cache memories within, or peripheral, to the cores can increase performance if cache locality of code is carefully maintained. Cache locality can ensure that the miss rate in the cache is minimal to reduce latency in program execution time. Notably, code programs can be sufficiently complex such that manual identification and segmentation of code for increasing cache performance such as cache locality can be impractical.

Embodiments herein concern a method and system for a cache optimizer that can be included during a linking process to improve a cache locality. According to one embodiment, the method and system can be included in a mobile communication device for improving inter-processor communication efficiency. The method can include profiling a performance of a program code during a run-time execution, logging the performance for producing a cache log, and rearranging a portion of program code in view of the cache log for producing a rearranged portion. The rearranged portion can be supplied as a new image to a memory management unit for managing at least one cache memory. Notably, the cache logger identifies code performance during a run-time operation of the mobile communication device that is fed back to a linking process to maximize a cache locality of reference.

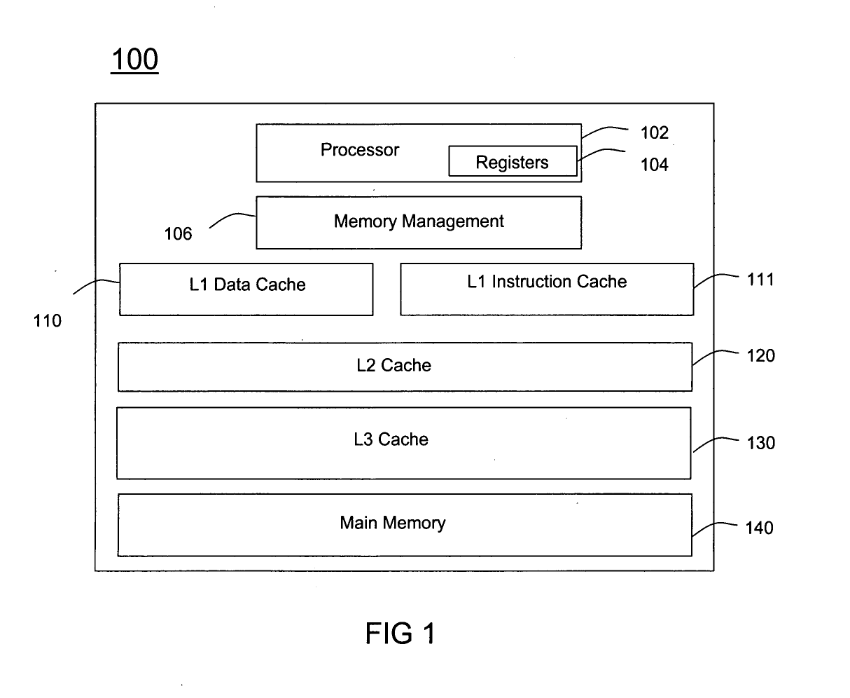

Referring to FIG. 1, a memory hierarchy 100 is shown. The memory hierarchy 100 can be included in a mobile communication device for optimizing a cache performance during a run-time operation. The memory hierarchy 100 can include a processor 102, a memory management block 106, and at least one cache memory 110-140. The processor 102 can include a set of registers 104 for storing data locally and which are accessible to the processor 102 without delay. The registers 104 are generally integrated within the processor 102 to provide data with low latency and high bandwidth. Briefly, the memory management block 106 controls how memory is arranged and accessed within the cache. The cache memories are located between the processor core 102 and the main memory 140. Briefly, the cache memories are used to store local copies of memory blocks to hasten access to frequently used data and instructions. The memory hierarchy 100 can include a variety of cache memories: data, instruction, and combined. Cache memory generally falls into two categories: cache with both data and instruction, and cache with a single, combined data/instruction. For example, the L1 cache can provide a memory cache for data 110 and a memory cache for instructions 111. The processor 102 can access the L1 cache memory at a higher rate than L2 cache memory. The L2 cache 120 can store more data as noted by its size than the L1 cache though access is generally slower. Notably, the L3 cache is larger than the L2 cache and having slower access time. The L3 cache can interface to the main memory 140 which can store more data and is also slower to access.

The processor 102 can access one of the cache memories for retrieving compiled code instructions from local memory at a higher rate than fetching the data from the more time-consuming main memory 140. A section of code instructions that are frequently accessed within a code loop can be stored as data by address and value in the L1 cache 111. For example, a small loop of instructions can be stored in a cache line of the L1 cache 111. The cache line can include an index, a tag, and a datum identifying the instruction, wherein the index can be the address of the data stored in main memory 140. The cache line is a unit of data that is moved between cache and memory when data is loaded into cache (e.g. typically 8 to 64 bytes in host processors and DSP cores). The processor 102 can check to see if the code section is in cache before retrieving the data from higher caches or the main memory 140.

The processor 102 can store data in the cache that is repeatedly called during code program execution. The cache increases the execution performance by temporarily storing the data in cache 110-140 for quick retrieval. Local data can be stored directly in the registers 104. The data can be stored in the cache by an address index. The processor 102 first checks to see if the memory location of the data corresponds to the address index of the data in the cache. If the data is not in the cache, the processor 102 proceeds to check the L2 cache, followed by the L3 cache, and so until, the data is directly accessed from the main memory. A cache hit occurs when the data the processor requests is in the cache. If the data is not in the cache, it is called a cache miss and the processor must generally wait longer to receive the data from the slower memory thereby increasing computational load and decreasing performance.

Accessing the data from cache reduces power consumption, which is advantageous for embedded processors in mobile communication devices having limited battery life. Embedded applications, running on processor cores with small simple caches, are generally software managed to maximize their efficiency and control what is cached. In general, the data within the cache is temporarily stored depending on a memory management unit, which is known in the art. The memory management unit controls how and when data will be placed in the cache and delegates permission as to how the data will be accessed.

Improving the data locality of applications can improve the number of cache hits in an effort to mitigate the processor/memory performance gap. A locality of reference implies that in a relatively large program, only small portions of the program are used at any given time. Accordingly, a properly managed cache can effectively exploit the locality of reference by preparing information for the processor prior to the processor executing the information, such as data or code. Referring to FIG. 1, the memory management block 106 restructures a program to reuse certain portions of data or code that fit in the cache to reduce cache misses.

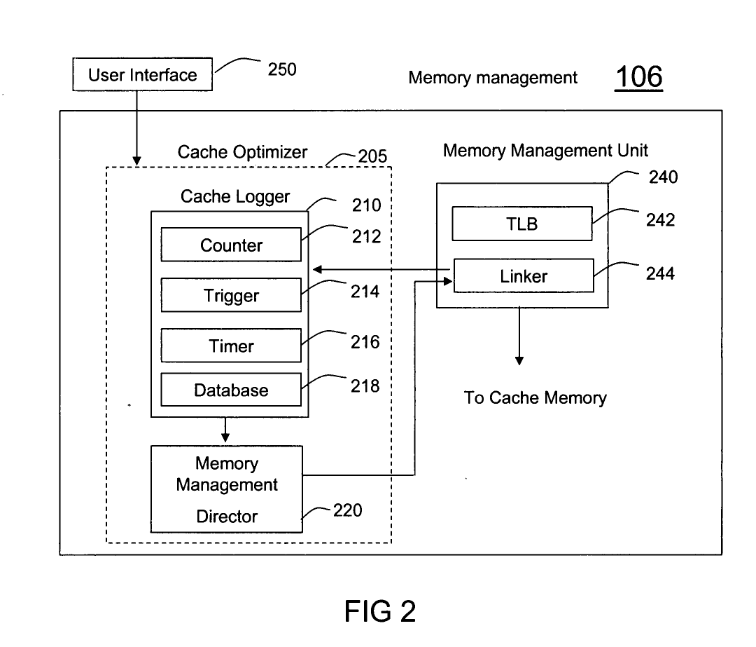

Referring to FIG. 2, a detailed block diagram of the memory management block 106 is shown. The memory management block 106 can include a cache logger 210 to profile an execution of a program during a runtime operation, a memory management director (MMD) 220 to rearrange the code program by re-linking relocatable code objects, and a memory management unit (MMU) 240 to actively manage address translation in the cache. Briefly, the cache logger 210 profiles cache performance and tracks the functions in program code that are frequently referenced by cache memory. Cache performance, such as the number of cache hits and misses, are saved to a cache log that is accessed by the MMD 220.

The cache logger 210 can include a counter 212, a trigger 214, a timer 216, and a database table 218. The counter 212 determines the number of times a function is called, and the timer 216 determines how often the function is called. The timer 216 provides information in the cache log concerning the temporal locality of reference. In one example, the timer 216 reveals the amount of time expiring from the last call of a function in cache compared to the current function call. The cache log captures statistics on the number of times a function has been called, the name of the function, the address location of the function, the arguments of the function, and dependencies such as external variables on the function. The trigger 214 activates a response in the MMD 220 when the frequency of a called function exceeds a threshold. The trigger threshold can be adaptive or static based on an operating mode. The database table 218 can keep count of the number of function cache misses and/or the addresses of the functions causing the cache misses.

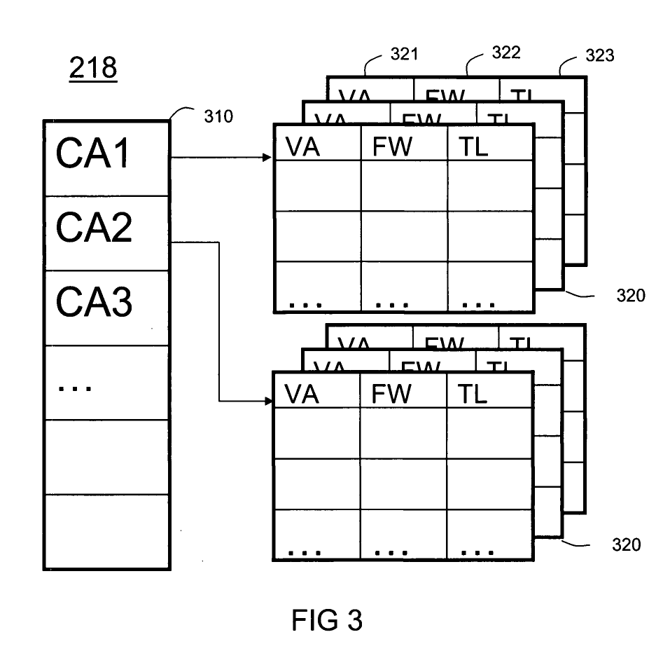

Referring to FIG. 3, the function database table 218 of the cache logger 210 is shown in greater detail. The function table 218 can be used in two modes of operations as illustrated: Function Monitoring, or Free Running. The ‘CA’ (calling address) column 310 holds a calling function that contributed to the first cache miss due to a change of program flow (Jump Subroutine). For example, CA1 can temporarily hold the operational code of a first calling function, and CA2 can temporarily hold the operational code of a second calling function. Each CA can point to one or more VA tables. For example CA1 can point to multiple VA tables 310, and CA2 can point to multiple VA tables 320. Referring back to FIG. 2, the memory management director 220 uses one of the CA fields in the linking process to determine the address where the function that caused the miss is re-linked to through the MMU 240. In comparison to the Function Monitoring mode of operation 320, the CA 310 for the Free Running mode of operation 330 is not pre-specified to monitor any function. In the Function Monitoring mode of operation, this field is used to specify misses related to this particular address which represents a function. For example, referring back to FIG. 2, the memory management director 220 uses one of the CA fields in the linking process to store the number of misses that a function caused with respect to having identified the address of the function. An address, as known in the art, can be a combination of an address and an extended address representing a Program Task ID (identifier) or Data ID.

The ‘VA’ (virtual address) column 321 holds the function virtual address which caused the cache miss of a calling function in CA 310. Each ‘CA’ can have its own ‘VA’ list. Note that after the re-linking process, both the ‘VA’and ‘CA’ can be changed if a re-linking over their address space is performed. The ‘FW’ (function weights) 322 column is accessed by the memory management director 220—supporting the dynamic mapping process and linker operation—decide which function in the list of ‘VA’ functions should be linked closer to the ‘CA’ when more than one ‘VA’ is tagged as needing to be re-linked. The fourth column ‘TL’ (temporal locality) 323 represents the threshold for each ‘VA’. The ‘TL’ field is a combination of frequency and an average time of occurrence of a ‘VA’. This is fed to the trigger mechanism shown in 214. For example, referring back to FIG. 2, the memory management director 220 accesses the TL column and triggers the dynamic mapping or linker operation to consider remapping the particular ‘VA’ when the threshold is exceeded.

In another aspect, the counter 212 determines the number of complexities within the code program. When the number of complexities reaches a pre-determined threshold the code can be flagged for optimization via the trigger 214. A performance criterion such as the number of millions of instructions per second (MIPS) can establish the threshold. For example, if the number of cache misses degrades MIPS performance below a certain level with respect to a normal or expected level, an optimization is triggered. Alternatively, the trigger 214 activates a response (e.g. optimization) in the MMD 220 when the count exceeds a cache miss to cache hit ratio.

Consequently, the MMD 220 rearranges a portion of the code program and re-links the rearranged portion to produce a new image. The MMD 220 receives profiled information in the cache log from the cache logger 210 and rearranges functions closer together based on the cache hit to miss ratio to improve the locality of reference. The MMD 220 dynamically links code objects using a linker in the MMU 240 thereby producing a new image for the MMU 240. The MMU 240 is known in the art, and can include a translation look aside buffer (TLB) 242 and a linker 244.

Briefly, the MMU 240 is a hardware component that manages virtual memory. The MMU 240 can include the TLB 242 which is a small amount of memory that holds a table for matching virtual addresses to physical addresses. Requests for data by the processor 102 (see FIG. 1) are sent to the MMU 240, which determines whether the data is in RAM or needs to be fetched from the main memory 140. The MMU 240 translates virtual to physical addresses and provides access permission control.

Briefly, the linker 244 is a program that processes relocatable object files. The linker re-links updated relocatable object modules and other previously created object modules to produce a new image. The linker 244 generates the executable image in view of the cache log and is loaded directly into the cache. The linker 244 generates a map file showing memory assignment of sections by memory space and a sorted list of symbols with their load time values. The cache logger 210, in turn, accesses the map file to determine the addresses of data and functions to optimize cache performance.

The input to the linker 244 is a set of relocatable object modules produced by an assembler or compiler. The term relocatable means that the data in the module has not yet been assigned to absolute addresses in memory; instead, each different section is assembled as though it started at relative address zero. When creating an absolute object module, the linker 244 reads all the relocatable object modules which comprise a program and assign the relocatable blocks in each section to an absolute memory address. The MMU 240 translates the absolute memory addresses to relative addresses during program execution.

Embodiments herein concern management of a re-linking operation using run-time profile analysis, and not necessarily the managing or optimization of the cache, which consequently follows from the managing of the linker 242. A real-time cache profile log is collected during run-time program execution and fed back to a linker to maximize a cache locality compile-time. Run-time code execution performance is maximized for efficiency by rearranging compiled code objects in real-time using address translation in the cache prior to linking. The methods described herein can be applied to any level of the memory hierarchy, including virtual memory, caches, and registers. It can be done either automatically, by a compiler, or manually, by the programmer.

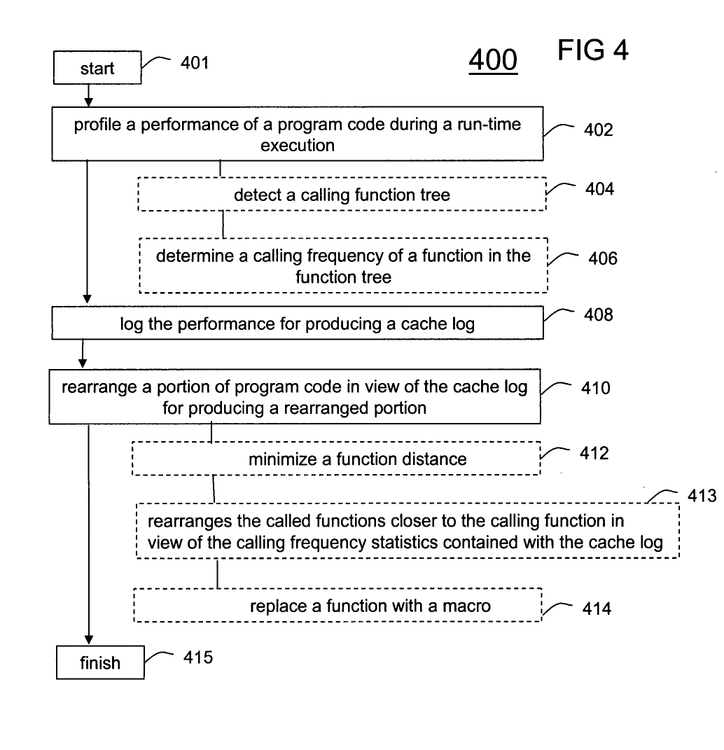

Referring to FIG. 4, a flow chart illustrates a method for run-time cache optimization. At step 401, the method can start. At step 402, a performance of a program code can be profiled during a run-time execution. For example, referring to FIG. 2, the cache logger 210 examines the code structure to identify disparate code sections. The cache logger 210 can perform a straight code inspection and detect calling functions trees (e.g. flowchart style) at step 404. As another example, at step 406, the cache logger 210 generates a first pass run through on the code to identify calling distances between functions. The calling distance is the address difference between two functions. In other words, step 406 can determine a calling frequency of a function in the function tree.

Referring back to FIG. 2, the counter 216 counts the number of times each function is called and associates a count with each function. The timer 216 identifies and associates a time stamp between calling functions. The trigger 214 flags which functions result in cache misses or hits and generates a cache performance profile. In one arrangement the trigger 214 can include hysteresis to trigger an optimization flag when a cache miss occurs on a specified section of memory. The cache logger 210 can include a user interface 250 for providing a cache configuration. For example, a user can specify a profile such as cache optimization range for an address space. When a function within the address space is accessed via the cache, the trigger 214 can initiate a code optimization in the MMD 220. In another arrangement, the program code can be statically recompiled based on the selected profile and the communication device can be reprogrammed with the new image.

As another example, the cache miss rate should not grow to the point of degrading performance and unexpectedly terminate a call. For example, during a voice call, the cache logger 210 tracks the cache miss rate and triggers a flag when the cache miss rate degrades operational performance with respect to a cache hit to miss ratio. The cache logger 210 assesses cache hit and miss rates during runtime for various operating modes, such as a dispatch or interconnect call. The MMD 220 rearranges the code objects when the cache miss to hit ratio exceeds 5% in order to bring the cache misses down. The cache miss to hit criteria can change depending on the operating mode.

The cache logger 210 and MMD 220 together constitute a cache optimizer 205 for rearranging the code objects to maximize cache locality and reduce the cache miss rate. The cache logger 210 captures the frequency of occurrence of functions called within the currently executing program code. The cache logger 210 tracks the addresses causing the cache miss and stores them in the cache log. The real-time profiling analysis is stored in the cache log and used by the MMD 220 to re-link the object files.

At step 408, the code performance can be logged for producing a cache log. For example, referring to FIG. 2, the cache logger 210 generates a second pass to examine visible calling frequencies between functions (e.g. detect large code loops calling functions). The cache logger 210 can determine which functions have been most frequently accessed in the cache. It also can determine the code size and complexity to determine compulsory misses, capacity misses, and conflict misses. The cache logger 210 identifies constructs within the code program such as pointers, indirectly accessed arrays, branches, and loops for establishing the level of code complexity. The cache logger 210 can optimize functions which result in increased calling function distances. The optimization provides performance improvements over compiler option optimizations. For example, when a small function (e.g. that may fit in a cache line) is being called frequently from few places, replacing the function with a macro increases locality in the cache.

The cache logger 210 can produce a cache log for various operating modes. For instance, a cache log can be generated and saved for a dispatch operation mode, an interconnect operation mode, a packet data operation mode and so on. Upon the phone entering an operation mode, a cache log associated with the operation mode can be loaded in the phone. The cache log can be used as a starting point for tuning a cache optimization performance of the phone. For example, the cache logger 210 saves a cache log for a dispatch call that is saved in memory and reloaded at power up when another dispatch call at a later time is initiated.

At step 410, a portion of program code can be rearranged in view of the cache log for producing a rearranged portion. For example, referring to FIGS. 2 and 3, at step 412, the MMD 220 rearranges the functions within the calling function trees closer to each other based on the calling tree. For example, at step 413, the MMD 220 also rearranges the called functions closer to the calling function in view of the calling frequency statistics contained with the cache log. The MMD 220 optimizes the object code structure based on the cache log and re-links the code dynamically for maximizing the number of cache hits. For example, the cache logger 210 continually updates a cache log during real-time operation to reveal the number of cache hits, and their corresponding functions, accessed by the cache. The MMD 220 analyzes the statistics from the cache log and adjusts the function call order and operation to maintain a cache hit ratio, such as a 95% hit rate. In another example, at step 414, the MMD 220 can replace a function with a macro. Once the portion of the program is rearranged in view of the cache log, the method is completed at step 415 until another profile is created.

The MMD 220 modifies the addresses in the linker in view of the cache log such that functions and data are positioned in the cache to have the highest cache hit performance during run-time processing. In once arrangement, it does so by placing functions closer together in code prior to linking. For example, a cache miss can occur when a first function, that depends on a second function, is farther away in address space than the second function. The cache can only store a portion of the first function before the cache must evict some of the data to allow for data of the second function. Data from the first function is replenished when the cache restores the first function. Notably, the cache performance degrades due to the latency involved in retrieving the memory for restoring the first function. Accordingly, the MMD 220 rearranges the code objects such that the first function address is closer in memory space than the second function. The MMD 220 rearranges the code relative to each other prior to re-linking and without having to re-compile the source code. The code objects are relocatable as a result of a previous linking. The step of rearranging the code objects addresses the spatial locality of reference for increasing cache performance.

The cache logger 210 and MMD 220 function independently of one another to rearrange code without disrupting the current cache configuration (e.g. High hit rate functions). In one arrangement, the cache logger 210 can apply weights to functions based on their importance, real-time requirements, frequency of occurrence, and the like in view of the cache log. For example, referring to FIG. 2, the TLB 242 can include a tag index entry associating the address of a data unit in cache to an address in memory. The cache logger 210 can weight the index to increase or decrease a count assigned to the function specified by the address within the cache log. The trigger 214 determines when the count from the weighted functions exceeds a threshold to invoke an action. The action causes the MMD 220 to rearrange the code objects for the weighted functions. Cache efficiency is optimized by modifying the relocation information in the linker based on run-time operation performance to maximize cache locality compile-time.

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiments of the invention is not so limited. Numerous modifications, changes, variations, substitutions and equivalents will occur to those skilled in the art without departing from the spirit and scope of the present embodiments of the invention as defined by the appended claims.

What is claimed is:

1. A system for run-time cache optimization, comprising
a cache logger, wherein the cache logger creates a profile of performance of a program code during a run-time execution thereby producing a cache log; and
a memory management director, wherein the memory management director rearranges at least a portion of said program code in view of said profile and produces a rearranged portion,
wherein said memory management director provides at least said portion of the program code to a memory management unit that manages at least one cache memory in accordance with said cache log.

2. The system of claim 1, wherein said cache logger further comprises:
a counter, wherein said counter counts the number of times a function within said program code is called;
a timer, wherein said timer determines how often said function is called;
a trigger, wherein said trigger activates a response when a count from the counter exceeds a cache miss to cache hit ratio; and
a database table, wherein said database table holds calling functions and cache count misses,
wherein said response re-links said rearranged portion to produce a new image.

3. The system of claim 1, wherein said cache logger identifies cache misses during a real-time operation of a communication device in said cache log that is fed back to a linking process to maximize a cache locality compile-time.

4. The system of claim 2, wherein said memory management director minimizes an address distance of a called function within said program code.

5. The system of claim 2, wherein said rearranging is based on a calling frequency of at least one function contained within said program code.

6. The system of claim 1, wherein said memory management director uses said rearranged portion of program code to reprogram a new memory map in accordance with said cache log.

7. The system of claim 1, wherein said memory management replaces a short function of said program code by a macro.

8. The system of claim 1, wherein a cache pre-processing rule is applied to at least one function of said program code during a linking operation.

9. The system of claim 1, wherein said cache logger logs a cache miss in real-time based on a set of rules, triggers, counters, timers, weights, radio modes and registers.

10. The system of claim 1, further including a user interface for providing a cache configuration, wherein said program code is statically recompiled in view of a selected profile.

11. A method for run-time cache optimization, comprising the steps of:
profiling a performance of a program code during a run-time execution;
logging said performance for producing a cache log; and
rearranging a portion of program code in view of said cache log for producing a rearranged portion,
wherein said rearranged portion is supplied to a memory management unit for managing at least one cache memory.

12. The method of claim 11, wherein said cache log is collected during a real-time operation of a communication device and is fed back to a linking process to maximize a cache locality compile-time.

13. The method of claim 11, further comprising
loading a saved profile corresponding with a run-time operating mode; and
reprogramming a new code image associated with said saved profile.

14. The method of claim 11, wherein the step of profiling further includes:
detecting a calling function tree; and
determining a calling frequency of a function in said function tree.

15. The method of claim 11, wherein the step of rearranging further includes one of:
minimizing a function distance; and
replacing a function with a macro.

16. The method of claim 11, wherein said cache log identifies cache misses and said rearranging optimizes a cache locality compile-time.

17. The method of claim 11, wherein said rearranging minimizes an address distance of a called function based on a calling frequency of said function within said program code.

18. The method of claim 11, further comprising
identifying at least one real-time operating mode within a radio;
saving at least one cache log associated with a performance of a program code executing in said real-time operating mode for producing at least one saved profile;
wherein a saved cache log and a program image is loaded into said radio when said radio enters a new operating mode.

19. A machine readable storage, having stored thereon a computer program having a plurality of code sections executable by a portable computing device for causing the portable computing device to perform the steps of:
profiling a performance of a program code during a run-time execution;
logging said performance for producing a cache log; and
rearranging a portion of program code in view of said cache log for producing a rearranged portion,
wherein said cache log is collected during a real-time operation of a communication device and is fed back to a linking process to maximize a cache locality compile time.

20. The machine readable storage of claim 19, further including the steps of:
minimizing the distance of a called function;
rearranging functions based on a calling frequency;
optimizing said functions to reduce a distance to other functions; and
replacing a short function by a macro,
wherein said cache log identifies cache misses with called functions causing said cache misses.
